(19) United States
(12) Patent Application Publication
(10) Pub. No.: US 2011/0067668 A1
(43) Pub. Date: Mar. 24, 2011

(54) OIL SUPPLY DEVICE FOR VEHICLE

(75) Inventors: Eiji Miyachi, Nishio-shi (JP); Yasuo Ozawa, Kariya-shi (JP); Hisashi Ono, Okazaki-shi (JP)

(73) Assignee: AISIN SEIKI KABUSHIKI KAISHA, Kariya-shi (JP)

(21) Appl. No.: 12/870,478

(22) Filed: Aug. 27, 2010

(30) Foreign Application Priority Data
Sep. 24, 2009 (JP) 2009-219058

(51) Int. Cl. F01M 1/02; F15D 1/00

(52) U.S. Cl. 123/196 R; 137/565.01

(57) ABSTRACT

An oil supply device for a vehicle includes an oil pump having a supply condition varying mechanism varying a supply condition of oil, a hydraulic actuator to which the oil is supplied from the oil pump, a lubricating system to which the oil is supplied from the oil pump, and an oil supply adjusting mechanism adjusting the supply condition of the oil from the oil pump to the hydraulic actuator and the lubricating system, wherein the supply condition of the oil to the supply condition varying mechanism and the oil supply adjusting mechanism is controlled by a single control valve.

### CROSS REFERENCE TO RELATED APPLICATIONS

This application is based on and claims priority under 35 U.S.C. §119 to Japanese Patent Application 2009-219058, filed on Sep. 24, 2009, the entire content of which is incorporated herein by reference.

### TECHNICAL FIELD

This disclosure relates to an oil supply device for a vehicle.

### BACKGROUND DISCUSSION

A known engine oil supply device disclosed in JP2004-143972A (hereinafter referred to as Reference 1) includes a mechanical oil pump, an electric oil pump, and a switching valve selectively varying a supply of oil from the electric oil pump to a variable valve timing device and an oil jet device. The mechanical oil pump is connected to the electric oil pump in order to allow the oil pump to operate at low power.

A known oil pump disclosed in JP2008-291825A (hereinafter referred to as Reference 2) includes a relative position varying means controlled by a hydraulic control valve. A relative position between central axes of inner and outer rotors is varied by the relative position varying means in order to prevent an unneeded operation of the oil pump.

In an oil supply device for a vehicle, for the purpose of an appropriate supply of oil from an oil pump, for example, a supply condition of the oil from the oil pump to a variable valve timing device (hydraulic actuator) and an oil jet device (oil lubricating system) is desired to vary at start of an internal combustion engine or depending on operating conditions of the internal combustion engine. In addition, a supply condition of the oil from the oil pump is expected to vary in order to prevent the oil pump from excessively supplying the oil to the hydraulic actuator and the oil lubricating system when the internal combustion engine is operated at high speed. Accordingly, it is assumed that a technique according to the engine oil supply device described in Reference 1 and a technique according to the oil pump described in Reference 2 are combined with each other.

However, in the case where the techniques disclosed in Reference 1 and Reference 2 are combined, the switching valve varying the supply condition of the oil from the electric oil pump to the hydraulic actuator and the oil lubricating system and multiple control valves of the hydraulic control valve controlling the relative position varying means are required for the oil supply device. As a result, the size and cost of the oil supply device may be increased.

A need thus exists for an oil supply device for a vehicle, which is not susceptible to the drawback mentioned above.

### SUMMARY

According to an aspect of this disclosure, an oil supply device for a vehicle includes an oil pump having a supply condition varying mechanism varying a supply condition of oil, a hydraulic actuator to which the oil is supplied from the oil pump, a lubricating system to which the oil is supplied from the oil pump, and an oil supply adjusting mechanism adjusting the supply condition of the oil from the oil pump to the hydraulic actuator and the lubricating system, wherein the supply condition of the oil to the supply condition varying mechanism and the oil supply adjusting mechanism is controlled by a single control valve.

According to another aspect of the disclosure, an oil supply device for a vehicle includes a hydraulic actuator provided at an internal combustion engine and being operated by a hydraulic pressure, a lubricating system lubricating the internal combustion engine, an oil pump including a supply condition varying mechanism and supplying the oil to the hydraulic actuator and the lubricating system, the supply condition varying mechanism varying a discharge rate of the oil, an oil supply adjusting mechanism arranged between the hydraulic actuator and the oil pump and between the lubricating system and the oil pump and distributing the oil, which is discharged from the oil pump, to the hydraulic actuator and the lubricating system, wherein a supply condition of the oil to the supply condition varying mechanism and the oil supply adjusting mechanism is controlled by a single control valve.

### BRIEF DESCRIPTION OF THE DRAWINGS

The foregoing and additional features and characteristics of this disclosure will become more apparent from the following detailed description considered with the reference to the accompanying drawing, wherein:

FIG. 1 is an oil passage routing chart of an oil supply device for a vehicle according to an embodiment disclosed here.

### DETAILED DESCRIPTION

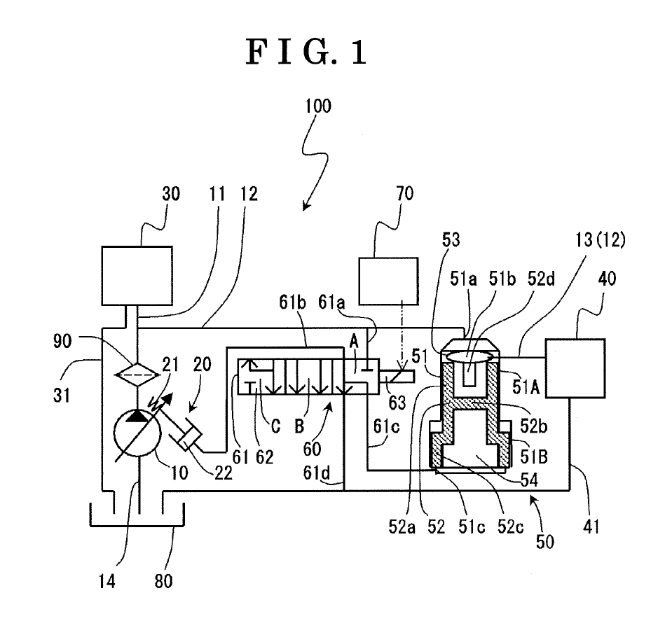

An oil supply device 100 for a vehicle according to an embodiment will be explained with reference to an illustration of a drawing as follows. FIG. 1 is an oil passage routing chart of the oil supply device 100 according to the embodiment. The oil supply device 100 includes an oil pump 10, a hydraulic actuator 30 to which oil is supplied from the oil pump 10, an engine lubricating system (lubricating system) 40 to which the oil is supplied from the oil pump 10, an oil supply adjusting valve (oil supply adjusting mechanism) 50, and an oil control valve (control valve) 60. The oil pump 10 is driven by an internal combustion engine while including a supply condition varying mechanism 20 that varies a supply condition (discharge rate) of the oil. The hydraulic actuator 30 is arranged at the internal combustion engine while being operated by a hydraulic pressure of the oil. The oil supply adjusting valve 50 distributes the oil, which is discharged from the oil pump 10, to the hydraulic actuator 30 and the engine lubricating system 40 and adjusts the supply condition of the oil to the hydraulic actuator 30 and the engine lubricating system 40. The oil control valve 60 controls the supply condition of the oil to the supply condition varying mechanism 20 and the oil supply adjusting valve 50.

A first oil passage 11 is arranged between the oil pump 10 and the hydraulic actuator 30. The oil from the oil pump 10 is supplied via the first oil passage 11 to the hydraulic actuator 30. The oil from the hydraulic actuator 30 is drained from an oil drain passage 31 connected to the hydraulic actuator 30.

A second oil passage 12 is arranged between the oil pump 10 and the engine lubricating system 40. The second oil passage 12 is diverged from the first oil passage 11. The oil from the oil pump 10 is supplied to the engine lubricating system 40 via the second oil passage 12. Further, the oil from the engine lubricating system 40 is drained from an oil drain passage 41 connected to the engine lubricating system 40. The oil supply adjusting valve 50 is connected to the second oil passage 12 so as to be positioned between the oil pump 10 and the engine lubricating system 40 and between the oil pump 10 and the hydraulic actuator 30.

The oil pump 10 includes a spring 21 and the supply condition varying mechanism 20. The spring 21 is arranged at one side of a protruding portion protruding from a retaining portion rotatably retaining an outer rotor. The supply/discharge of the oil between the oil control valve 60 and a hydraulic chamber 22 is performed by the supply condition varying mechanism 20 so that an eccentric position of the outer rotor relative to an inner rotor is varied. As a result, the oil pump 10 varies the supply condition of the oil. The hydraulic chamber 22 is arranged at the other side of the protruding portion protruding from the retaining portion and is separated from the one side of the protruding portion in a liquid-tight manner. Further, the oil pump 10 suctions the oil from an oil pan 80 via an oil suction passage 14 and discharges the oil to the first oil passage 11 via an oil filter 90.

The oil supply adjusting valve 50 includes a valve body 51 formed into a stepped cylindrical shape having a small diameter cylindrical portion 51A and a large diameter cylindrical portion 51B. A connecting portion 51a connecting to the second oil passage 12 and a connecting portion 51b connecting to a third oil passage 13 configuring a portion of the second oil passage 12 and communicating with the engine lubricating system 40 are arranged at the small diameter cylindrical portion 51A. The connecting portion 51a is positioned closer to the second oil passage 12 than the connecting portion 51b. A connecting portion 51c connecting to the oil control valve 60 is arranged at the large diameter cylindrical portion 51B. A valve 52 is slidably arranged within the valve body 51. The valve 52 includes a cylindrical portion 52a, a small diameter portion 52b, and a large diameter portion 52c. The cylindrical portion 52a slides within the small diameter cylindrical portion 51A to connect and disconnect a communication between the connecting portion 51a and the connecting portion 51b. The small diameter portion 52b is continuously formed with the cylindrical portion 52a while separating the small diameter cylindrical portion 51A from the large diameter cylindrical portion 51B in a liquid-tight manner. The large diameter portion 52c is continuously formed with the small diameter portion 52b while sliding within the large diameter cylindrical portion 51B and separating the small diameter cylindrical portion 51A from the large diameter cylindrical portion 51B in a liquid-tight manner. A slit 52d is formed in the cylindrical portion 52a. The slit 52d communicates between inner and outer sides of the cylindrical portion 52a formed in a notched shape facing the connecting portion 51b.

The small diameter cylindrical portion 51A, the connecting portion 51a, the connecting portion 51b, the cylindrical portion 52a, the small diameter portion 51b, and the slit 52d vary the supply condition of the oil to the engine lubricating system 40 while configuring an oil passage control portion 53 that varies the supply condition of the oil to the hydraulic actuator 30. The large diameter cylindrical portion 51B, the connecting portion 51c, and the large diameter portion 52c configure a pressure chamber 54 sliding therein the valve 52. The large diameter portion 52c has a diameter larger than a diameter of the small diameter portion 52b. For example, when the same magnitude pressure is applied to the large diameter portion 52c and the small diameter portion 52b, a force acting from the large diameter portion 52c (pressure chamber 54) to the small diameter portion 52b (oil passage control portion 53) is generated to the valve 52.

The oil control valve 60 includes an oil passage 61a connecting to the second oil passage 12 leading to the oil pump 10, an oil passage 61b connecting to the hydraulic chamber 22 (supply condition varying mechanism 20), an oil passage 61c connecting to the pressure chamber 54 (oil supply adjusting valve 50), and a valve body 61 to which an oil drain passage 61d is connected. The oil of the valve body 61 is drained to the oil pan 80 via the oil drain passage 61d. A spool 62 and a solenoid 63 that drives the spool 62 are attached to the valve body 61. The spool 62 switches a connection between the oil passages 61a, 61b, and 61c and the oil drain passage 61d. The oil control valve 60 is controlled by a duty ratio based on a signal of an ECU 70 computing a detection value from a pressure status of the oil in the hydraulic actuator 30 and the engine lubricating system 40 and rotations of the internal combustion engine, and the like. The ECU 70 controls the oil control valve 60 on the basis of the duty ratio to switch a flow of the oil from the oil control valve 60 via the oil passage 61 b to the hydraulic chamber 22 and a flow of the oil from the oil control valve 60 to the pressure chamber 54 via the oil passage 61c and to the oil drain passage 61d via the oil passage 61c.

An operation of the oil supply device 100 will be explained as follows. According to the oil supply device 100 of the embodiment, when the internal combustion engine starts or rotates at low speed, the oil control valve 60 is controlled based on a duty ratio (for example, the oil control valve 60 is energized at zero or one hundred percent duty cycle) by the ECU 70 so as to be in Condition A (a first position) shown in the most right in FIG. 1 and the oil passage 61b connecting to the hydraulic chamber 22 and the oil passage 61c connecting to the pressure chamber 54 are connected to the oil drain passage 61d. At this time, the oil pump 10 is configured so that the eccentric position of the outer rotor relative to the inner rotor is set at a large value by the supply condition varying mechanism 20 and that a discharge rate of the oil is high. The connecting portion 51b is opened by the valve 52 slid toward the pressure chamber 54 by the oil flowing into the oil passage control portion 53; thereby, the oil is supplied to the engine lubricating system 40. Further, the oil discharged from the oil pump 10 is supplied to the hydraulic actuator 30 via the first oil passage 11. An oil supply limiting means limiting a supply of the oil from the oil pump 10 to the hydraulic actuator 30 is not arranged therebetween. Accordingly, the oil is consistently supplied from the oil pump 10 to the hydraulic actuator 30 under Condition A (the first condition). Consequently, a non-operational state of the hydraulic actuator 30 due to no supply of the oil may be prevented.

Further, when the oil is not supplied sufficiently to operate the hydraulic actuator 30, for example, in the case where the discharge rate of the oil from the oil pump 10 is low, the oil control valve 60 is controlled based on a duty ratio (for example, the oil control valve 60 is energized at fifty percent duty cycle) by the ECU 70 so as to be in Condition B (a second position) shown in the intermediate position in FIG. 1. Further, the oil passage 61b connecting to the hydraulic chamber 22 is connected to the oil drain passage 61d and the oil passage 61a communicating with the oil pump 10 via the second oil passage 12 is connected to the pressure chamber 54. At this time, the oil pump 10 is configured so that the large value of the eccentric position of the outer rotor relative to the inner rotor is maintained by the supply condition varying mechanism 20 and that the discharge rate of the oil is high. The connecting portion 51b is closed by the valve 52 slid toward the oil passage control portion 53 by the oil supplied to the pressure chamber 54; thereby the oil to be supplied to the engine lubricating system 40 is limited and the oil is supplied to the hydraulic actuator 30. In addition, a minimum volume of the oil required for the engine lubricating system 40 is supplied by the slit 52d. In other words, when the oil control valve 60 is under Condition B (the second position), the supply of the oil to the engine lubricating system 40 is limited and a limited volume of the oil is supplied to the hydraulic actuator 30. Accordingly, the oil supply adjusting valve 50 serves as a throttle valve supplying the oil preferentially to the hydraulic actuator 30 rather than to the engine lubricating system 40. As described above, even when the discharge rate of the oil from the oil pump 10 is low, the hydraulic actuator 30 may not be brought into the non-operational state due to an insufficient hydraulic pressure while the supply of the oil to the engine lubricating system 40 is limited (reduced). However, in the case of the oil pump 10 that is a mechanical oil pump receiving the rotations of the internal combustion engine so as to be driven, for example, when a discharge rate of the oil of the oil pump 10 is low, the number of rotations of the internal combustion engine is small. Accordingly, slide members configuring the engine lubricating system 40 are slid at low speed of the internal combustion engine; therefore, lubrication of the internal combustion engine may be performed with a small volume of the oil. As a result, although the supply of the oil to the engine lubricating system 40 is limited (reduced), overheating, seizure, and the like of the engine lubricating system 40 due to an insufficient lubrication may be inhibited.

Furthermore, in the case where the hydraulic actuator 30 is in operation while the internal combustion engine is operated at medium or high speed, the oil control valve 60 is controlled based on a duty ratio (for example, the oil control valve 60 is energized at one hundred or zero percent duty cycle) by the ECU 70 so as to be in Condition C (a third position) shown in the most left side relative to the ECU 70 in FIG. 1. Further, the hydraulic chamber 22 connects to the second oil passage 12 which communicates with the oil pump 10, via the oil passage 61b and the oil passage 61c while the pressure chamber 54 connects to the second oil passage 12 via the oil passage 61c and the oil passage 61a. At this time, the oil pump 10 is configured so that the eccentric position of the outer rotor relative to the inner rotor is set at a small value by the supply condition varying mechanism 20 and that the discharge rate of the oil is low; thereby the oil is prevented from being excessively supplied. The connecting portion 51b is closed by the valve 52 slid toward the oil passage control portion 53 by the oil supplied to the pressure chamber 54; thereby, the supply of the oil from the oil pump 10 to the engine lubricating system 40 is limited and the oil is supplied to the hydraulic actuator 30. In addition, the minimum volume of the oil required for the engine lubricating system 40 is supplied by the slit 52d. In other words, when the oil control valve 60 is under Condition C (the third position), the oil supply adjusting valve 50 serves as the throttle valve supplying the oil preferentially to the hydraulic actuator 30 rather than to the engine lubricating system 40 and the discharge rate of the oil from the oil pump 10 is reduced by the supply condition varying mechanism 20. Accordingly, the volume of the oil to be supplied to the hydraulic actuator 30 and the engine lubricating system 40 that are oil supply destinations is reduced by the supply condition varying mechanism 20 and the volume of the oil to be supplied to the engine lubricating system 40 is minimized by the oil supply adjusting valve 50. As described above, even when the discharge rate of the oil from the oil pump 10 increases, the volume of the oil to be supplied to the hydraulic actuator 30 and the engine lubricating system 40 is secured and the oil may be prevented from being supplied to the hydraulic actuator 30 and the engine lubricating system 40 more than necessary.

Thus, according to the oil supply device 100 of the embodiment, the supply condition of the oil relative to the hydraulic actuator 30 and the engine lubricating system 40 is varied depending on operating conditions of the internal combustion engine from the start of the operation to the operation at high speed and the supply condition of the oil from the oil pump 10 is varied. Consequently, the oil may be appropriately supplied to the internal combustion engine by the oil supply device 100.

In addition, the supply condition of the oil from the oil control valve 60 to the hydraulic actuator 30, the engine lubricating system 40, and the supply condition varying mechanism 20 of the oil pump 10 is controlled based on the duty ratio. Accordingly, the supply condition of the oil is controlled by the single oil control valve 60. As a result, the size and cost of the oil supply device 100 may be reduced and the oil supply device 100 may be simplified. Moreover, the oil supply device 100 may be downsized and simplified only by arranging the oil drain passage 61d at the oil control valve 60.

As described above, the oil pump 10 varying the supply condition of the oil is applied to the oil supply device 100 of the embodiment; therefore, an additional oil pump is not required. Further, the supply condition of the oil to the hydraulic actuator 30 and the engine lubricating system 40 is controlled by the single oil control valve 60 to thereby control the supply condition of the oil to the supply condition varying mechanism 20 and the oil supply adjusting valve 50. Accordingly, the size and cost of the oil supply device 100 are reduced and the oil supply device 100 is simplified. Furthermore, the oil is drained from the oil control valve 60 via the single oil drain passage 61d, leading to the reduction of the size and cost of the oil supply device 100.

According to the aforementioned embodiment, the oil supply adjusting valve 50 is configured to consistently supply the oil to the hydraulic actuator 30 and the engine lubricating system 40.

According to the aforementioned embodiment, the oil supply device 100 further includes the first oil passage 11 supplying the oil from the oil pump 10 to the hydraulic actuator 30 and the second oil passage 12 supplying the oil from the oil pump 10 to the engine lubricating system 40. The second oil passage 12 is diverged from the first oil passage 11. The oil supply adjusting valve 50 is connected to the second oil passage 12 so as to be positioned between the oil pump 10 and the engine lubricating system 40.

Since the oil supply adjusting valve 50 is arranged as described above, an oil passage route may be simplified.

According to the aforementioned embodiment, the oil control valve 60 is controlled based on the duty ratio to vary the supply condition of the oil to the supply condition varying mechanism 20, the hydraulic actuator 30, and the engine lubricating system 40.

Accordingly, the supply condition of the oil to the hydraulic actuator 30 and the engine lubricating system 40 is independently controlled based on the duty ratio by the single oil control valve 60.

According to the aforementioned embodiment, the oil supply adjusting valve 50 includes the oil passage control portion 53 connecting to the second oil passage 12 and the pressure chamber 54 connecting to the oil control valve 60. Further, the oil passage control portion 53 is connected to the engine lubricating system 40 via the third oil passage 13 configuring a portion of the second oil passage 12.

Accordingly, the oil supply adjusting valve 50 is simply configured to control the supply condition of the oil to the hydraulic actuator 30 in accordance with the supply condition of the oil in the pressure chamber 54.

According to the aforementioned embodiment, the oil control valve 60 includes the first position (Condition) A where the oil is not supplied to both of the supply condition varying mechanism 20 and the pressure chamber 54, the second position (Condition) B where the oil is supplied to either the supply condition varying mechanism 20 or the pressure chamber 54, and the third position (Condition) C where the oil is supplied to both of the supply condition varying mechanism 20 and the pressure chamber 54.

Accordingly, the supply condition of the oil to the hydraulic actuator 30 and the engine lubricating system 40 is independently controlled by the single oil control valve 60 that is easily configured only by having the first position A, the second position B, and the third position C.

According to the aforementioned embodiment, the oil supply adjusting valve 50 limits the supply of the oil to the engine lubricating system 40 when the oil is supplied to the pressure chamber 54.

Accordingly, the supply of the oil to the engine lubricating system 40 that is one of supply destinations of the oil supplied from the oil pump 10 is limited; thereby the oil is preferentially supplied to the hydraulic actuator 30 that is the other of the supply destinations of the oil supplied from the oil pump 10.

According to the aforementioned embodiment, the oil pump 10 limits the supply of the oil to the hydraulic actuator 30 and the engine lubricating system 40 when the oil is supplied to the supply condition varying mechanism 20.

Accordingly, the discharge rate of the oil from the oil pump 10 is limited; therefore, the supply of the oil to the hydraulic actuator 30 and the engine lubricating system 40 is reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An oil supply device for a vehicle, comprising:
an oil pump including a supply condition varying mechanism varying a supply condition of oil;
a hydraulic actuator to which the oil is supplied from the oil pump;
a lubricating system to which the oil is supplied from the oil pump; and
an oil supply adjusting mechanism adjusting the supply condition of the oil from the oil pump to the hydraulic actuator and the lubricating system,
wherein the supply condition of the oil to the supply condition varying mechanism and the oil supply adjusting mechanism is controlled by a single control valve.

2. The oil supply device according to claim 1, wherein the oil supply adjusting mechanism is configured to consistently supply the oil to the hydraulic actuator and the lubricating system.

3. The oil supply device according to claim 1, further comprising a first oil passage supplying the oil from the oil pump to the hydraulic actuator and a second oil passage supplying the oil from the oil pump to the lubricating system, wherein the second oil passage is diverged from the first oil passage, and the oil supply adjusting mechanism is connected to the second oil passage so as to be positioned between the oil pump and the lubricating system.

4. The oil supply device according to claim 1, wherein the control valve is controlled based on a duty ratio to vary the supply condition of the oil to the supply condition varying mechanism, the hydraulic actuator, and the lubricating system.

5. The oil supply device according to claim 3, wherein the control valve is controlled based on a duty ratio to vary the supply condition of the oil to the supply condition varying mechanism, the hydraulic actuator, and the lubricating system.

6. The oil supply device according to claim 3, wherein the oil supply adjusting mechanism includes an oil passage control portion connecting to the second oil passage and a pressure chamber connecting to the control valve, and
wherein the oil passage control portion is connected to the lubricating system via a third oil passage configuring a portion of the second oil passage.

7. The oil supply device according to claim 6, wherein the control valve includes a first position where the oil is not supplied to both of the supply condition varying mechanism and the pressure chamber, a second position where the oil is supplied to either the supply condition varying mechanism or the pressure chamber, and a third position where the oil is supplied to both of the supply condition varying mechanism and the pressure chamber.

8. The oil supply device according to claim 6, wherein the oil supply adjusting mechanism limits the supply of the oil to the lubricating system when the oil is supplied to the pressure chamber.

9. The oil supply device according to claim 7, wherein the oil supply adjusting mechanism limits the supply of the oil to the lubricating system when the oil is supplied to the pressure chamber.

10. The oil supply device according to claim 1, wherein the oil pump limits the supply of the oil to the hydraulic actuator and the lubricating system when the oil is supplied to the supply condition varying mechanism.

11. The oil supply device according to claim 2, wherein the oil pump limits the supply of the oil to the hydraulic actuator and the lubricating system when the oil is supplied to the supply condition varying mechanism.

12. The oil supply device according to claim 3, wherein the oil pump limits the supply of the oil to the hydraulic actuator and the lubricating system when the oil is supplied to the supply condition varying mechanism.

13. The oil supply device according to claim 4, wherein the oil pump limits the supply of the oil to the hydraulic actuator and the lubricating system when the oil is supplied to the supply condition varying mechanism.

14. The oil supply device according to claim 5, wherein the oil pump limits the supply of the oil to the hydraulic actuator and the lubricating system when the oil is supplied to the supply condition varying mechanism.

15. The oil supply device according to claim 6, wherein the oil pump limits the supply of the oil to the hydraulic actuator and the lubricating system when the oil is supplied to the supply condition varying mechanism.

16. The oil supply device according to claim 7, wherein the oil pump limits the supply of the oil to the hydraulic actuator and the lubricating system when the oil is supplied to the supply condition varying mechanism.

17. The oil supply device according to claim 8, wherein the oil pump limits the supply of the oil to the hydraulic actuator and the lubricating system when the oil is supplied to the supply condition varying mechanism.

18. The oil supply device according to claim 9, wherein the oil pump limits the supply of the oil to the hydraulic actuator and the lubricating system when the oil is supplied to the supply condition varying mechanism.

19. An oil supply device for a vehicle, comprising:
a hydraulic actuator provided at an internal combustion engine and being operated by a hydraulic pressure;
a lubricating system lubricating the internal combustion engine;
an oil pump including a supply condition varying mechanism and supplying the oil to the hydraulic actuator and the lubricating system, the supply condition varying mechanism varying a discharge rate of the oil;
an oil supply adjusting mechanism arranged between the hydraulic actuator and the oil pump and between the lubricating system and the oil pump and distributing the oil, which is discharged from the oil pump, to the hydraulic actuator and the lubricating system,
wherein a supply condition of the oil to the supply condition varying mechanism and the oil supply adjusting mechanism is controlled by a single control valve.

20. The oil supply device according to claim 17, wherein the oil supply adjusting mechanism is configured to consistently supply the oil to the hydraulic actuator and the lubricating system.
